(19) United States
(12) Patent Application Publication
(10) Pub. No.: US 2009/0099851 A1
(43) Pub. Date: Apr. 16, 2009

(54) ADAPTIVE BIT POOL ALLOCATION IN SUB-BAND CODING

(75) Inventors: Laurent Pilati, Antibes (FR); Mickael Jougit, Mougins Le Haut (FR)

Correspondence Address: FIALA & WEAVER, P.L.L.C.;C/O CPA GLOBAL, P.O. BOX 52050, MINNEAPOLIS, MN, 55402, US

(73) Assignee: BROADCOM CORPORATION, Irvine, CA (US)

(21) Appl. No.: 12/018,443

(22) Filed: Jan. 23, 2008

Related U.S. Application Data
(60) Provisional application No. 60/979,235, filed on Oct. 11, 2007.

(51) Int. Cl. G10L 19/00

(52) U.S. Cl. 704/500

(57) ABSTRACT

In a Bluetooth™ Sub-band Codec (SBC), the size of a bit pool allocated for encoding is adapted in a manner that is dependent upon the audio content that is being encoded. In one implementation, the size of the bit pool is increased during periods when the audio input signal represents an active audio signal, such as speech or music, and decreased when the audio input signal represents background noise or silence. This has the effect of increasing the bit rate (and thus the audio quality) in the presence of speech or music but decreasing the bit rate (and thus the audio quality) in the presence of background noise or silence. By adapting the size of the bit pool in this manner, the quality of the encoded bit-stream transmitted from the SBC encoder may be improved or power may be conserved depending upon the implementation.

### CROSS-REFERENCE TO RELATED APPLICATIONS

This application claims priority to U.S. Provisional Patent Application No. 60/979,235, filed Oct. 11, 2007 and entitled “Adaptive Bit Pool Allocation in Sub-band Coding,” the entirety of which is incorporated by reference herein.

### BACKGROUND OF THE INVENTION

### Field of the Invention

The invention generally relates to systems and methods for improving audio quality and/or conserving power in telephones and audio terminals, including but not limited to handsets or headsets.

### BACKGROUND

The Bluetooth™ Sub-band Codec (SBC) is a low computational complexity audio coding system designed to obtain high quality audio at medium bit rates. SBC is used in all Bluetooth™ products offering audio streaming and will soon be used in all Bluetooth™ products offering wideband voice communication. SBC uses four or eight sub-bands, an adaptive bit allocation algorithm, and simple adaptive block PCM quantizers. SBC is fully described in Appendix B of the Advanced Audio Distribution Profile (A2DP) specification (Adopted Version 1.0, May 22, 2003)(referred to herein as “the A2DP specification”). The A2DP specification defines how high quality audio can be streamed from one device to another over a Bluetooth™ connection. This specification is incorporated by reference in its entirety as if fully set forth herein.

In SBC, an eight-bit integer value denoted bitpool is used to indicate the size of the bit pool to be allocated for encoding an audio stream. Using bitpool and other codec parameters (sampling frequency, channel mode, block length and the number of sub-bands), the bit rate and frame length of the audio stream may be determined as follows:

bit_rate=8*frame_length*fₛ/nrof_subbands/nrof_blocks,

where bit_rate is the bit rate, and where fₛ, nrof_subbands and nrof_blocks denote the sampling frequency, the number of sub-bands and the number of blocks, respectively. The bit rate is expressed in kilobits per second (kb/s) and the sampling frequency is expressed in kilohertz (kHz). The frame length (frame_length) is expressed in bytes as

frame_length=4+(4*nrof_subbands*nrof_channels)/8+┌nrof_blocks*nrof_channels*bitpool/8┐

for mono and dual channel modes, and

frame_length=4+(4*nrof_subbands*nrof_channels)/8+┌join*nrof_subbands+nrof_blocks*bitpool)/8┐

for stereo and joint stereo channel modes. Here, nrof_channels denotes the number of channels. When joint stereo is used, join=1, otherwise join=0. These equations use a ceiling function. The ceiling function of a real number x, denoted ┌x┐, is a function that returns the smallest integer not less than x.

It can be seen from the foregoing that in SBC, given a fixed sampling frequency, channel mode, block length and number of sub-bands, the bit rate will be driven solely by bitpool. Thus, to increase the bit rate and thereby achieve improved audio quality, a relatively large bitpool may be used. However, this improved audio quality will come at the cost of increased power consumption by the encoder and decoder. Alternatively, to decrease the bit rate and thereby reduce power consumption, a relatively small bitpool may be used. However, this reduced power consumption will come at the cost of lower audio quality.

What is needed, then, is a technique that allows an audio communication system that uses SBC encoding to improve the quality of an encoded audio stream without increasing or substantially increasing power consumption by the SBC encoder and decoder. What is also needed is a technique that allows an audio communication system that uses SBC encoding to reduce the power consumption by the SBC encoder and decoder without reducing or substantially reducing the quality of an encoded audio stream.

### BRIEF SUMMARY OF THE INVENTION

In accordance with one aspect of the present invention, the size of a bit pool allocated for performing SBC encoding is adapted in a manner that is dependent upon the audio content that is being encoded. As set forth in the A2DP Specification, the size of the bit pool is defined using an integer value denoted bitpool. The bitpool parameter may be fixed or adjustable depending upon the implementation of the SBC encoder. An embodiment of the present invention utilizes an adjustable implementation to increase bitpool during periods when an audio input signal represents an active audio signal, such as speech or music, and to decrease bitpool when the audio input signal represents background noise or silence. This has the effect of increasing the bit rate (and thus the audio quality) in the presence of speech or music but decreasing the bit rate (and thus the audio quality) in the presence of a background noise or silence.

By adapting bitpool based on the content of the audio input signal, the foregoing approach may be used to improve the quality of the encoded bit-stream transmitted from the SBC encoder without increasing or substantially increasing power consumption. The encoded bit-stream will have a better quality because the most important part of the audio input signal will be encoded at a higher bit rate. However, power is conserved because the least significant information is encoded at a lower bit rate.

Alternatively, by adapting bitpool based on the content of the audio input signal, the foregoing approach may be used to reduce power consumption without reducing or substantially reducing the quality of the encoded bit-stream transmitted from the SBC encoder. This is achieved by encoding the audio input signal at a bit rate that maintains the current audio quality during the most important part of the audio input signal but encoding the least significant information using a lower bit rate that conserves power.

In particular, a method for encoding an audio signal in an SBC encoder is described herein. In accordance with the method, a portion of an audio input signal, such as a frame of the audio input signal, is analyzed. The size of a bit pool allocated for encoding the audio input signal is then determined based on the analysis. This step may include setting a bitpool parameter to a determined integer value. The audio input signal is then encoded using a bit pool of the determined size.

In accordance with the foregoing method, analyzing a portion of an audio input signal may include determining if the portion of the audio input signal represents an active audio signal, wherein the active audio signal is speech or music. This may in turn comprise measuring the power of the portion of the audio input signal. Determining the size of a bit pool allocated for encoding the audio input signal may include increasing the size of the bit pool responsive to an increase in the measured power of the portion of the audio signal as compared to a measured power of a previously-analyzed portion of the audio input signal. Determining the size of a bit pool allocated for encoding the audio input signal may also include reducing the size of the bit pool responsive to a reduction in the measured power of the portion of the audio input signal as compared to a measured power of a previously-analyzed portion of the audio input signal.

A system for encoding an audio signal in an SBC encoder is also described herein. The system includes first logic, second logic and third logic. The first logic is configured to analyze a portion, such as a frame, of an audio input signal. The second logic is configured to determine the size of a bit pool allocated for encoding the audio input signal based on the analysis. The second logic may also include logic configured to set a bitpool parameter to a determined integer value based on the analysis. The third logic is configured to encode the audio input signal using a bit pool of the determined size.

In accordance with the foregoing system, the first logic may include logic configured to determine if the portion of the audio input signal represents an active audio signal, wherein the active audio signal is speech or music. This logic may in turn include logic configured to measure the power of the portion of the audio input signal. The second logic may include logic configured to increase the size of the bit pool responsive to an increase in the measured power of the portion of the audio input signal as compared to a measured power of a previously-analyzed portion of the audio input signal. The second logic may also include logic configured to reduce the size of the bit pool responsive to a reduction in the measured power of the portion of the audio input signal as compared to a measured power of a previously-analyzed portion of the audio input signal.

A computer program product is also described herein. The computer program product comprises a computer-readable medium having computer program logic recorded thereon for enabling a processor to encode an audio signal in a Bluetooth™ Sub-band Codec (SBC). The computer program logic includes first means, second means and third means. The first means are programmed to enable the processor to analyze a portion, such as a frame, of an audio input signal. The second means are programmed to enable the processor to determine the size of a bit pool allocated for encoding the audio input signal based on the analysis. The second means may also include means for enabling the processor to set a bitpool parameter to a determined integer value. The third means are programmed to enable the processor to encode the audio input signal using a bit pool of the determined size.

In accordance with the foregoing computer program product, the first means may include means for enabling the processor to determine if the portion of the audio input signal represents an active audio signal, wherein the active audio signal is speech or music. The means for enabling the processor to determine if the portion of the audio input signal represents an active audio signal may in turn include means for enabling the processor to measure the power of the portion of the audio input signal. The second means may include means for enabling the processor to increase the size of the bit pool responsive to an increase in the measured power of the portion of the audio input signal as compared to a measured power of a previously-analyzed portion of the audio input signal. The second means may also include means for enabling the processor to reduce the size of the bit pool responsive to a reduction in the measured power of the portion of the audio input signal as compared to a measured power of a previously-analyzed portion of the audio input signal.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 is a block diagram of a system in which a first device streams audio content, such as music, to a second device, wherein the audio content is encoded using a Bluetooth™ Sub-band Codec (SBC).

FIG. 2 is a block diagram of a system in which a near end user of a first device is engaged in a voice call with a far end user of a second device, wherein the near end user carries on the voice call via a third device that is communicatively connected to the first device over a Bluetooth™ Extended Synchronous Connection-Oriented (eSCO) link.

FIG. 3 depicts a flowchart of a general method for encoding an audio signal in a Bluetooth™ SBC encoder in accordance with an embodiment of the present invention.

FIG. 4 depicts a first graph that shows an audio input signal and a second graph that shows the value of a bitpool parameter over time for first and second implementations of an SBC encoder responsive to receiving the audio input signal.

FIG. 5 is a graph that shows the PESQ (Perceptual Evaluation of Speech Quality) score of an audio signal when encoded using a fixed bitpool implementation and the PESQ score of the audio signal when encoded using an adaptive bitpool implementation in accordance with an embodiment of the present invention.

FIG. 6 is a block diagram of a computer system in which an embodiment of the present invention may be implemented.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### A. Exemplary Operating Environments

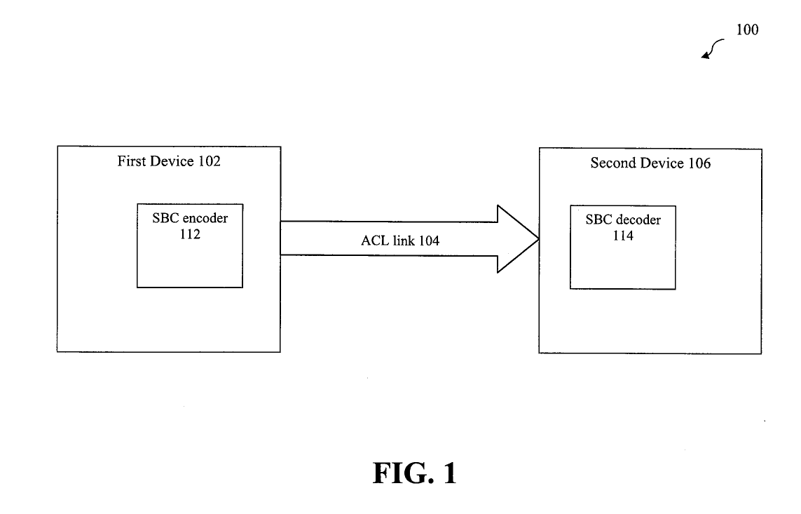

An embodiment of the present invention may be implemented in a wireless audio streaming scenario which will now be described in reference to FIG. 1. In particular, FIG. 1 depicts a system 100 in which a first device 102 streams audio content, such as music, to a second device 106, wherein the audio content is encoded using a Bluetooth™ Sub-band Codec (SBC). First device 102 thus acts as an audio source and second device 106 acts as an audio sink. In the scenario depicted in FIG. 1, the audio content is streamed over a Bluetooth™ Asynchronous Connectionless (ACL) link 104. The manner in which such a link may be established is specified as part of the Bluetooth™ specification and thus need not be described herein.

First device 102 may comprise, for example, an MP3 player (such as an iPod® sold by Apple Computer, Inc.), a cellular phone, a personal computer, or any other system or device that may be configured to wirelessly transmit audio content over a Bluetooth™ ACL link. Second device 106 may comprise a Bluetooth™ headset, a Bluetooth™ speaker, or any other system or device that may be configured to wirelessly receive audio content over a Bluetooth™ ACL link.

As shown in FIG. 1, first device 102 includes an SBC encoder 112 and second device 106 includes an SBC decoder 114. SBC encoder 112 is configured to apply SBC encoding to an audio input signal in the manner described in Appendix B of the A2DP specification, thereby generating an encoded bit-stream. The encoded bit-stream is transmitted over ACL link 104 and is received by second device 106. SBC decoder 114 within second device 106 is configured to apply SBC decoding to the received encoded bit-stream in the manner described in Appendix B of the A2DP specification, thereby generating an audio output signal.

In accordance with an embodiment of the present invention, SBC encoder 112 is further configured to dynamically adapt the size of a bit pool to be allocated for performing SBC encoding in a manner that is dependent upon the audio content that is being encoded. Generally speaking, SBC encoder 112 is configured to increase the size of the bit pool during periods when the audio input signal represents an active audio signal, such as speech or music, and to decrease the size of the bit pool when the audio input signal represents background noise or silence. This has the effect of increasing the bit rate (and thus the audio quality) in the presence of speech or music but decreasing the bit rate (and thus the audio quality) in the presence of background noise or silence. This feature, and the benefits thereof, will be discussed in more detail below.

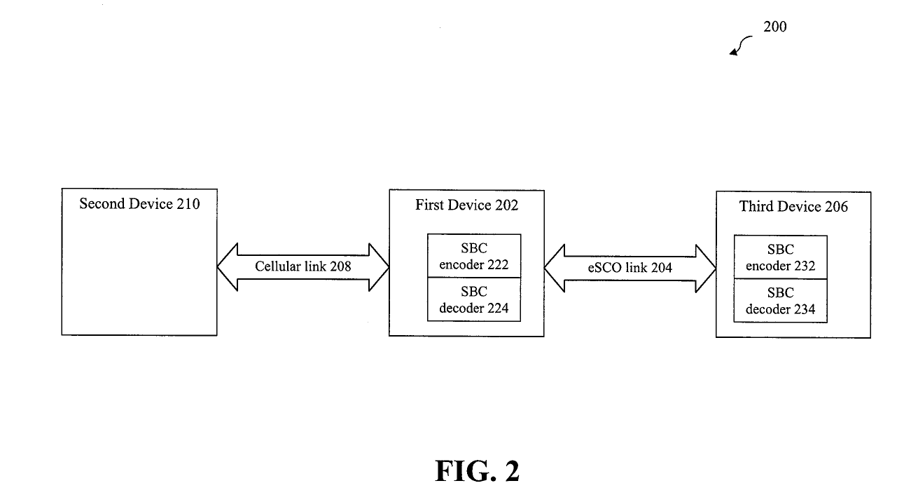

An embodiment of the present invention may also be implemented in a voice call scenario which will now be described in reference to FIG. 2. In particular, FIG. 2 depicts a system 200 in which a near end user of a first device 202 is engaged in a phone call with a far end user of a second device 210. During the phone call, wideband speech is communicated over a cellular link 208 between first device 202 and second device 210 in a well-known manner. First device 202 may comprise, for example, a cellular phone, personal computer, or any other type of audio gateway. Second device 210 may comprise, for example, a 3G cellular phone. However, these examples are not intended to be limiting, and first device 202 and second device 210 may each comprise any type of device capable of supporting the communication of wideband speech signals over a cellular link.

As further shown in FIG. 2, the near end user may carry on the voice call via a third device 206 that is communicatively connected to first device 202 over a Bluetooth™ Extended Synchronous Connection-Oriented (eSCO) link 204. Third device 206 may comprise, for example, a Bluetooth™ headset or Bluetooth™ car kit. The manner in which such an eSCO link may be established is specified as part of the Bluetooth™ specification and thus need not be described herein.

To exchange compressed wideband speech over eSCO link 204, each of first device 202 and third device 206 include an SBC encoder and decoder. In particular, first device 202 includes an SBC encoder 222 and an SBC decoder 224 while third device 206 includes an SBC encoder 232 and an SBC decoder 234. Each of SBC encoder 222 and SBC encoder 232 is configured to apply SBC encoding to an audio input signal in the manner described in Appendix B of the A2DP specification, thereby generating an encoded bit-stream. The encoded bit-stream is transmitted over eSCO link 204. Each of SBC decoder 224 and SBC decoder 234 is configured to apply SBC decoding to the received encoded bit-stream in the manner described in Appendix B of the A2DP specification, thereby generating an audio output signal.

In accordance with an embodiment of the present invention, one or both of SBC encoder 222 and SBC encoder 232 is further configured to dynamically adapt the size of a bit pool allocated during the performance SBC encoding in a manner that is dependent upon the audio content that is being encoded. Generally speaking, each SBC encoder is configured to increase the size of the bit pool during periods when the audio input signal represents an active audio signal, such as speech or music, and to decrease the size of the bit pool when the audio input signal represents background noise or silence. This has the effect of increasing the bit rate (and thus the audio quality) in the presence of speech or music but decreasing the bit rate (and thus the audio quality) in the presence of a background noise or silence. This feature, and the benefits thereof, will be discussed in more detail below.

The foregoing operating environments of system 100 and system 200 have been described by way of example only. Persons skilled in the relevant art(s), based on the teachings provided herein, will readily appreciate that the present invention may be implemented in other operating environments. For example, the present invention may be implemented in any system or device that is configured to perform SBC encoding.

### B. SBC Bit Allocation Pool Adaptation Based on Audio Content/Audio Activity Detection

In accordance with an embodiment of the present invention, the size of a bit pool allocated for performing SBC encoding is adapted in a manner that is dependent upon the audio content that is being encoded. As set forth in the A2DP Specification, the size of the bit pool is defined using an integer value denoted bitpool. The bitpool parameter may be fixed or adjustable depending upon the implementation of the SBC encoder. An embodiment of the present invention utilizes an adjustable implementation to increase bitpool during periods when the audio input signal represents an active audio signal, such as speech or music, and to decrease bitpool when the audio input signal represents background noise or silence. This has the effect of increasing the bit rate (and thus the audio quality) in the presence of speech or music but decreasing the bit rate (and thus the audio quality) in the presence of background noise or silence.

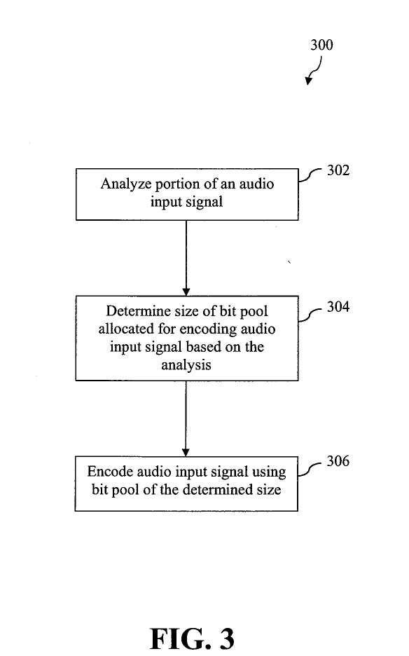

By way of illustration, FIG. 3 depicts a flowchart 300 of a general method for encoding an audio signal in a Bluetooth™ SBC encoder in accordance with an embodiment of the present invention. The method of flowchart 300 may be implemented in any system or device that is configured to perform SBC encoding. For example, and without limitation, the method of flowchart 300 may be implemented in SBC encoder 112 of FIG. 1, or in SBC encoder 222 and/or SBC encoder 232 of FIG. 2. The steps of flowchart 300 will now be described.

As shown in FIG. 3, the method of flowchart 300 begins at step 302 in which the SBC encoder analyzes a portion of an audio input signal. The portion of the audio signal may be, for example and without limitation, a frame or sub-frame of the audio signal. Analyzing the portion of the audio input signal may include, but is not limited to, determining if the portion of the audio signal represents an active audio signal, wherein the active audio signal is speech or music. Determining if the portion of the audio signal represents an active audio signal may include, but is not limited to, measuring the power of the portion of the audio input signal.

At step 304, the SBC encoder determines the size of a bit pool allocated for encoding the audio input signal based on the analysis performed in step 302. This step may include, for example and without limitation, increasing the size of the bit pool responsive to an increase in a measured power of the portion of the audio signal as compared to a measured power of a previously-analyzed portion of the audio input signal. This step may also include, for example and without limitation, reducing the size of the bit pool responsive to a reduction in a measured power of the portion of the audio signal as compared to a measured power of a previously-analyzed portion of the audio input signal. Determining the size of the bit pool allocated for encoding the audio input signal may include, for example and without limitation, setting a bitpool parameter to a determined integer value.

At step 306, the SBC encoder encodes the audio input signal using a bit pool of the size determined in step 304. The encoding may be carried out in a manner described in Appendix B of the A2DP specification. The encoded bit-stream generated in step 306 may then be transmitted to another device over a wireless link.

By adapting bitpool based on the content of the audio input signal as described above, the foregoing approach may be used to improve the quality of the encoded bit-stream transmitted from the SBC encoder without increasing or substantially increasing power consumption. The encoded bit-stream will have a better quality because the most important part of the audio input signal will be encoded at a higher bit rate. However, power is conserved because the least significant information is encoded at a lower bit rate.

Alternatively, by adapting bitpool based on the content of the audio input signal as described above, the foregoing approach may be used to reduce power consumption without reducing or substantially reducing the quality of the encoded bit-stream transmitted from the SBC encoder. This is achieved by encoding the audio input signal at a bit rate that maintains the current audio quality during the most important part of the audio signal but encoding the least significant information using a lower bit rate that conserves power.

Thus, the manner in which bitpool is adapted may depend on the constraints of a given application system. For example, in an application system in which a primary constraint is audio quality, bitpool may be adapted in a manner that increases audio quality. In an application system in which a primary constraint is power saving, bitpool may be adapted in a manner that reduces power consumption.

The determination of the bitpool value may be made on a frame-by-frame basis, although the invention is not so limited. For example, in one embodiment, the power of a frame of the audio input signal is measured. Then, a bitpool value is selected based on the power of the frame, wherein a relatively larger bitpool is selected for a high-power frame and a relatively smaller bitpool is selected for a low-power frame. Of course, the determination of bitpool may also be made less frequently. For example, the determination may be made once every n frames, where n is a positive integer greater than 1. The determination of bitpool may also be made more frequently. For example, the determination may be made multiple times per frame, such as once every sub-frame or once every n sub-frames, where n is a positive integer greater than 1.

Persons skilled in the relevant art(s) will appreciate that measuring the power of the frame is just one method for determining if the frame represents an active audio signal, such as speech or music, or if the frame represents background noise or silence. Other methods for making this determination may be used as well.

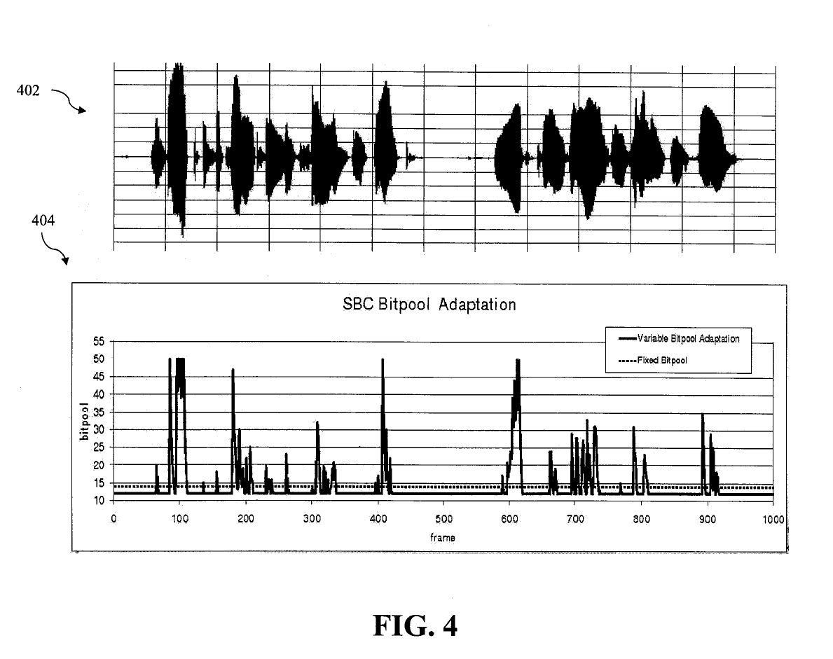

FIG. 4 presents one example of adaptation of the SBC bit pool in accordance with an embodiment of the present invention. In particular, FIG. 4 includes a graph 402 showing the amplitude of an audio input signal received by an SBC encoder over time. FIG. 4 further includes a graph 404 showing the value of the bitpool parameter over time for a first implementation of the SBC encoder (indicated with a dotted line) and for a second implementation of the SBC encoder (indicated with a solid line) responsive to receiving the audio input signal shown in graph 402.

As shown in graph 404, the first implementation of the SBC encoder uses a bitpool value that is fixed—in other words, the bitpool value stays the same over time. As a result, the frame size and bit rate associated with the encoded bit-stream generated by the SBC encoder will remain constant, and thus the audio quality will remain constant even during periods of background noise or silence.

As further shown in graph 404, the second implementation of the SBC encoder adapts the value of bitpool based on the measured power of the audio input signal in accordance with one embodiment of the present invention. Thus, the value of bitpool increases as the amplitude (and therefore the power) of the audio input signal increases and decreases as the amplitude (and therefore the power) of the audio input signal decreases. As a result, the frame size and bit rate associated with the encoded bit-stream generated by the SBC encoder will increase when the power of the signal increases (corresponding to periods of speech or music), and the audio quality will increase during these significant portions of the signal. Furthermore, the frame size and bit rate associated with the encoded bit-stream generated by the SBC encoder will decrease when the power of the signal decreases (corresponding to periods of background noise or silence), and the audio quality will decrease during these less significant portions of the signal.

Because a lower minimum bitpool value is used in the second implementation of the SBC encoder, the same average bitpool value as used by the first implementation can be achieved over time. This ensures that the power consumption of both the first and the second implementation of the SBC encoder will be roughly the same, even though the second implementation will produce a higher quality audio signal as perceived by the end user.

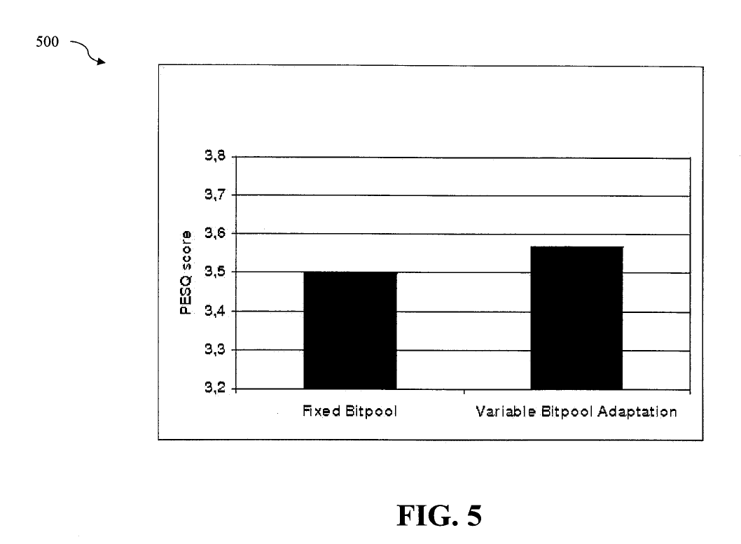

A comparison of the quality of the encoded audio signal is shown in FIG. 5, which shows the PESQ (Perceptual Evaluation of Speech Quality) score of the audio signal when encoded using the fixed bitpool implementation and the PESQ score of the audio signal when encoded using the adaptive bitpool implementation. As will be appreciated by persons skilled in the relevant art(s), PESQ is an ITU algorithm that is used to emulate MOS, which is “mean opinion score,” a listening test for speech codecs. As shown in FIG. 5, the PESQ score of the adaptive bitpool implementation exceeds that of the fixed bitpool implementation, indicating that the adaptive bitpool implementation produces a higher quality audio signal.

In accordance with an alternate embodiment of the present invention, the adaptive bitpool implementation can be modified to optimize power consumption as opposed to audio quality by appropriate reduction of the minimum and maximum bitpool values.

Where the audio input signal is a wideband speech signal, an implementation of the present invention effectively adds Voice Activity Detection (VAD) functionality to the SBC encoder. Such functionality has heretofore not been a part of an SBC encoder, as SBC has only been used to transport music. However, because a mechanism for transporting wideband speech is currently being added to the Bluetooth™ specification, this functionality will greatly benefit SBC encoders used for encoding wideband speech signals in the future.

An embodiment of the present invention may also be used by a multimedia source to conserve power when streaming music. The manner in which the size of the bit allocation pool is determined may be different in this case.

An implementation of the present invention advantageously requires no change to the structure, function or operation of the SBC decoder.

### C. Hardware and Software Implementations

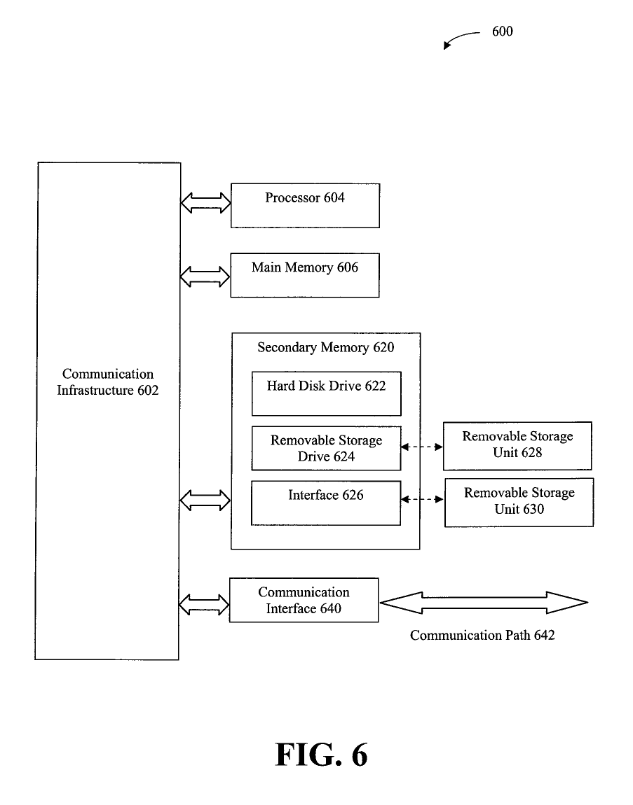

The following description of a general purpose computer system is provided for the sake of completeness. The present invention can be implemented in hardware, or as a combination of software and hardware. Consequently, the invention may be implemented in the environment of a computer system or other processing system. An example of such a computer system 600 is shown in FIG. 6. In the present invention, all of the SBC encoding operations described above in Section B, for example, can execute on one or more distinct computer systems 600, to implement the various methods of the present invention.

Computer system 600 includes one or more processors, such as processor 604. Processor 604 can be a special purpose or a general purpose digital signal processor. Processor 604 is connected to a communication infrastructure 602 (for example, a bus or network). Various software implementations are described in terms of this exemplary computer system. After reading this description, it will become apparent to a person skilled in the relevant art(s) how to implement the invention using other computer systems and/or computer architectures.

Computer system 600 also includes a main memory 606, preferably random access memory (RAM), and may also include a secondary memory 620. Secondary memory 620 may include, for example, a hard disk drive 622 and/or a removable storage drive 624, representing a floppy disk drive, a magnetic tape drive, an optical disk drive, or the like. Removable storage drive 624 reads from and/or writes to a removable storage unit 628 in a well known manner. Removable storage unit 628 represents a floppy disk, magnetic tape, optical disk, or the like, which is read by and written to by removable storage drive 624. As will be appreciated by persons skilled in the relevant art(s), removable storage unit 628 includes a computer usable storage medium having stored therein computer software and/or data.

In alternative implementations, secondary memory 620 may include other similar means for allowing computer programs or other instructions to be loaded into computer system 600. Such means may include, for example, a removable storage unit 630 and an interface 626. Examples of such means may include a program cartridge and cartridge interface (such as that found in video game devices), a removable memory chip (such as an EPROM, or PROM) and associated socket, and other removable storage units 630 and interfaces 626 which allow software and data to be transferred from removable storage unit 630 to computer system 600.

Computer system 600 may also include a communications interface 640. Communications interface 640 allows software and data to be transferred between computer system 600 and external devices. Examples of communications interface 640 may include a modem, a network interface (such as an Ethernet card), a communications port, a PCMCIA slot and card, etc. Software and data transferred via communications interface 640 are in the form of signals which may be electronic, electromagnetic, optical, or other signals capable of being received by communications interface 640. These signals are provided to communications interface 640 via a communications path 642. Communications path 642 carries signals and may be implemented using wire or cable, fiber optics, a phone line, a cellular phone link, an RF link and other communications channels.

As used herein, the terms “computer program medium” and “computer usable medium” are used to generally refer to media such as removable storage units 628 and 630, a hard disk installed in hard disk drive 622, and signals received by communications interface 640. These computer program products are means for providing software to computer system 600.

Computer programs (also called computer control logic) are stored in main memory 606 and/or secondary memory 620. Computer programs may also be received via communications interface 640. Such computer programs, when executed, enable the computer system 600 to implement the present invention as discussed herein. In particular, the computer programs, when executed, enable processor 600 to implement the processes of the present invention, such as any of the methods described herein. Accordingly, such computer programs represent controllers of the computer system 600. Where the invention is implemented using software, the software may be stored in a computer program product and loaded into computer system 600 using removable storage drive 624, interface 626, or communications interface 640.

In another embodiment, features of the invention are implemented primarily in hardware using, for example, hardware components such as application-specific integrated circuits (ASICs) and gate arrays. Implementation of a hardware state machine so as to perform the functions described herein will also be apparent to persons skilled in the relevant art(s).

### D. Conclusion

While various embodiments of the present invention have been described above, it should be understood that they have been presented by way of example only, and not limitation. It will be understood by those skilled in the relevant art(s) that various changes in form and details may be made to the embodiments of the present invention described herein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method for encoding an audio signal in a Bluetooth™ Sub-band Codec (SBC), comprising:
analyzing a portion of an audio input signal;
determining the size of a bit pool allocated for encoding the audio input signal based on the analysis; and
encoding the audio input signal using a bit pool of the determined size.

2. The method of claim 1, wherein analyzing the portion of the audio input signal comprises:
determining if the portion of the audio input signal represents an active audio signal, wherein the active audio signal is speech or music.

3. The method of claim 2, wherein determining if the portion of the audio input signal represents an active audio signal comprises:
measuring the power of the portion of the audio input signal.

4. The method of claim 3, wherein determining the size of the bit pool allocated for encoding the audio input signal comprises:
increasing the size of the bit pool responsive to an increase in the measured power of the portion of the audio input signal as compared to a measured power of a previously-analyzed portion of the audio input signal.

5. The method of claim 3, wherein determining the size of the bit pool allocated for encoding the audio input signal comprises:
reducing the size of the bit pool responsive to a reduction in the measured power of the portion of the audio input signal as compared to a measured power of a previously-analyzed portion of the audio input signal.

6. The method of claim 1, wherein analyzing the portion of the audio input signal comprises:
analyzing a frame of the audio input signal.

7. The method of claim 1, wherein determining the size of the bit pool allocated for encoding the audio input signal comprises:
setting a bitpool parameter to a determined integer value.

8. A system for encoding an audio signal in a Bluetooth™ Sub-band Codec (SBC), comprising:
first logic configured to analyze a portion of an audio input signal;
second logic configured to determine the size of a bit pool allocated for encoding the audio input signal based on the analysis; and
third logic configured to encode the audio input signal using a bit pool of the determined size.

9. The system of claim 8 wherein the first logic comprises:
logic configured to determine if the portion of the audio input signal represents an active audio signal, wherein the active audio signal is speech or music.

10. The system of claim 9, wherein the logic configured to determine if the portion of the audio input signal represents an active audio signal comprises:
logic configured to measure the power of the portion of the audio input signal.

11. The system of claim 10, wherein the second logic comprises:
logic configured to increase the size of the bit pool responsive to an increase in the measured power of the portion of the audio input signal as compared to a measured power of a previously-analyzed portion of the audio input signal.

12. The system of claim 10, wherein the second logic comprises:
logic configured to reduce the size of the bit pool responsive to a reduction in the measured power of the portion of the audio input signal as compared to a measured power of a previously-analyzed portion of the audio input signal.

13. The system of claim 8, wherein the first logic comprises:
logic configured to analyze a frame of the audio input signal.

14. The system of claim 8, wherein the second logic comprises:
logic configured to set a bitpool parameter to a determined integer value.

15. A computer program product comprising a computer-readable medium having computer program logic recorded thereon for enabling a processor to encode an audio signal in a Bluetooth™ Sub-band Codec (SBC), the computer program logic comprising:
first means for enabling the processor to analyze a portion of an audio input signal;
second means for enabling the processor to determine the size of a bit pool allocated for encoding the audio input signal based on the analysis; and
third means for enabling the processor to encode the audio input signal using a bit pool of the determined size.

16. The computer program product of claim 15, wherein the first means comprises:
means for enabling the processor to determine if the portion of the audio input signal represents an active audio signal, wherein the active audio signal is speech or music.

17. The computer program product of claim 16, wherein the means for enabling the processor to determine if the portion of the audio input signal represents an active audio signal comprises:
means for enabling the processor to measure the power of the portion of the audio input signal.

18. The computer program product of claim 17, wherein the second means comprises:
means for enabling the processor to increase the size of the bit pool responsive to an increase in the measured power of the portion of the audio input signal as compared to a measured power of a previously-analyzed portion of the audio input signal.

19. The computer program product of claim 17, wherein the second means comprises:
means for enabling the processor to reduce the size of the bit pool responsive to a reduction in the measured power of the portion of the audio input signal as compared to a measured power of a previously-analyzed portion of the audio input signal.

20. The computer program product of claim 15, wherein the first means comprises:
means for enabling the processor to analyze a frame of the audio input signal.

21. The computer program product of claim 15, wherein the second means comprises:
means for enabling the processor to set a bitpool parameter to a determined integer value.
